(19) United States
(12) Patent Application Publication
(10) Pub. No.: US 2011/0057529 A1
(43) Pub. Date: Mar. 10, 2011

(54) MOUNTING METHOD FOR FITTING A PERMANENT MAGNET IN A RETAINING ELEMENT

(76) Inventors: Maik Seidel, Harsum (DE); Miro Bekavac, Korntal-Muenchingen (DE)

(21) Appl. No.: 12/735,243

(22) PCT Filed: Dec. 17, 2008
(86) PCT No.: PCT/EP2008/067709

§ 371 Date: Sep. 27, 2010

(30) Foreign Application Priority Data
Dec. 28, 2007 (DE) 102007063307.8

(51) Int. Cl. H02K 21/02; B23P 11/00

(52) U.S. Cl. 310/152; 29/428

(57) ABSTRACT

A mounting method is provided for fitting a permanent magnet in a retaining element, the permanent magnet being held by a coating material, the at least one permanent magnet first being at least partially coated by an elastic coating material prior to being fitted, and mounted in the retaining element in the subsequent step.

### FIELD OF THE INVENTION

The present invention relates to a mounting method for fitting a permanent magnet in a retaining element.

### BACKGROUND INFORMATION

The use of so-called “buried magnets” in rotors in synchronous machines having permanent magnet excitation is generally discussed in German patent document DE 101 31 474 A1, for example. In this type of affixation, magnets are axially inserted into a lamellar pack assembled from individually stamped lamellae and fixed in place in the correct position using various fixation arrangements. The advantage of this technique is that it allows the use of cost-effective block-shaped magnets. Disadvantageous is the complex assembly and fixation technology due to unfavorable manufacturing tolerances of the magnets.

### SUMMARY OF THE INVENTION

The provided solution endeavors to simplify and shorten the mounting processes and to increase the process stability of the fixation technology. If prior to the fitting in a retaining element (e.g., the rotor of an electric machine), the at least one permanent magnet is first at least partially coated by an elastic coating material and only then installed in the retaining element in a subsequent step, it is possible to achieve preliminary fixation of the permanent magnet in the retaining element via the elastic coating material. This prevents the permanent magnets from sliding in the retaining element and not achieving their setpoint positions prior to the introduction of an impregnation arrangement. Elastomers, copolymers made of duroplast and thermoplast, for example, as well as polymer mixtures have shown to be suitable coating materials. For example, it is provided that the coating material covers the permanent magnet on one side or multiple sides, which also may amount only to partial coating, for instance. Then, the coated permanent magnet is placed in the seat of the electromagnetically excitable component of an electric machine. Sliding of the permanent magnets in the seat is avoided solely by the increased friction between seat and coating material. Changes in the position of the permanent magnets in the electromagnetically excitable component are then prevented even better if the dimensions of the coating material are adapted in such a way that a press-fit exists between the permanent magnets provided with the coating material, and the seat. In this case, the coating material gives a little during the insertion into the seat, and shavings are produced at the same time as a result of pressing the permanent magnet and its coating into the seat. A press-fit, for example, is easily verifiable in this way.

An additional, improved fixation of the permanent magnet in the seat of the electromagnetically excitable component of the electric machine is achieved by applying an additional adhesive layer on the permanent magnet and its coating material. This adhesive layer improves the adhesion between the permanent magnet or its coating material and the seat of the electromagnetically excitable component. On the one hand, this is able to improve the adhesion; on the other hand, a type of form-fit between the adhesive layer, and thus the permanent magnet, and the seat may be achieved by an expansion of the adhesive layer and/or the coating material, for example. The expandable material may expand under the action of an internal or external reaction-triggering arrangement, for instance. Such an internal reaction-triggering arrangement may, for example, be a crosslinking structure or arrangement contained in the coating material. An external reaction-triggering arrangement may be the action of radiation or heat, for instance.

Finally, an electric machine having a permanent magnet is provided, which is mounted according to a mounting method outlined above.

The exemplary embodiments and/or exemplary methods of the present invention will be elucidated in greater detail in the following text based on the figures.

### BRIEF DESCRIPTION OF THE DRAWINGS

FIG. 1 shows an electric machine having a rotor and a rotor reciprocator element.

FIG. 2 shows a mounting method in schematic form.

FIG. 3a shows an example of a coated permanent magnet.

FIG. 3b shows another example of a coated permanent magnet.

FIG. 3c shows another example of a coated permanent magnet.

FIG. 3d shows another example of a coated permanent magnet.

FIG. 4 shows a side view of a retaining element having a recess and a permanent magnet disposed therein, the permanent magnet being provided with a reactive coating material.

FIG. 5 shows a side view of a retaining element having a permanent magnet in a recess, the permanent magnet being coated both by a coating material and an adhesive layer.

### DETAILED DESCRIPTION

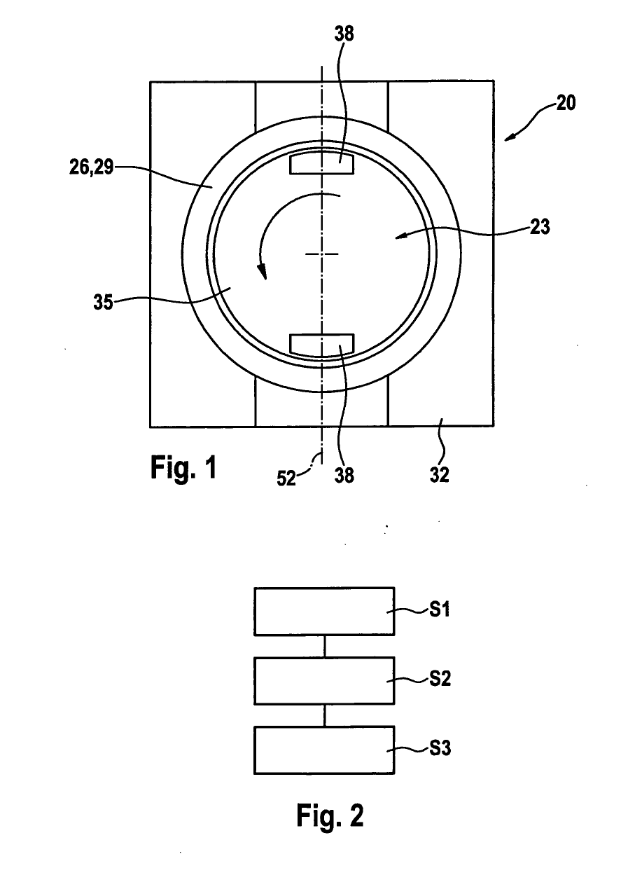

An electric machine 20 shown in FIG. 1 is provided with a rotatably supported rotor 23 as electrically acting component on the one hand, and a rotor reciprocator element 26 disposed across from it, on the other, the latter normally being implemented as stator 29. Rotor reciprocator element 26 is permanently mounted in a housing 32 of electric machine 20. Depending on the use of electric machine 20, be it as motor or as generator, electrical or electromagnetic forces are acting between rotor 23 and rotor reciprocator element 26, which either have a driving effect (motor) or an inhibiting effect (generator).

Rotor 23 is rotatably supported in the geometrical center of rotor reciprocator element 26, in the generally known manner. Rotor 23 is made up of a rotor core 35, which is able to be excited with the aid of two permanent magnets 38 in the exemplary embodiment shown.

FIG. 2 shows the mounting method in heavily schematized form. According to first step S1, a permanent magnet 38 is first at least partially coated by an elastic coating material. According to step S2, coated permanent magnet 38 is to be inserted in a seat 41 of an electromagnetically excitable component (rotor 23) of electric machine 20. According to step S3, fixation of permanent magnet 38 is provided.

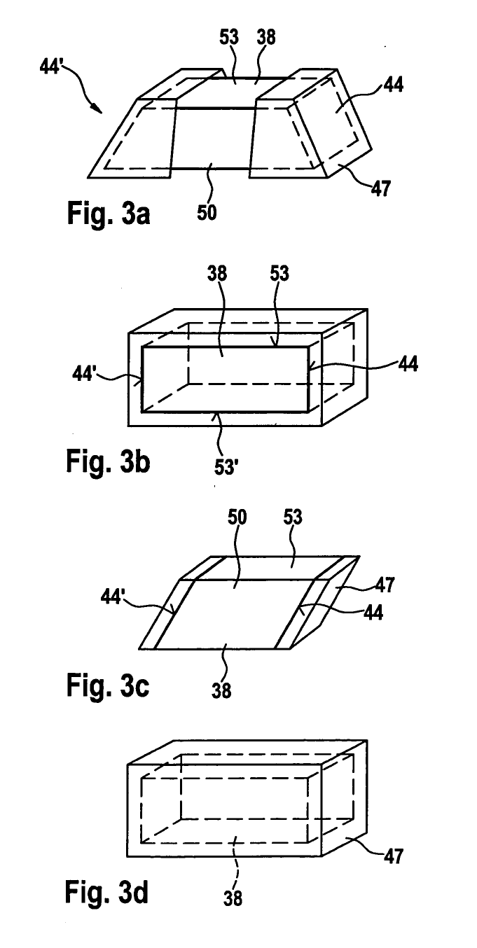

FIG. 3a shows a prismatic permanent magnet 38, which has a trapezoidal cross-section. This trapezoidal permanent magnet 38 has two ends, which have an oblique orientation relative to each other, i.e., at an angle not equal to 180°. In this exemplary embodiment, permanent magnet 38 is coated by coating material 47 both on these two surfaces 44 having an oblique orientation to each other, and on the surfaces adjoining surfaces 44. The adjoining areas are designated by reference numerals 50 and 53. Furthermore, the two other surfaces 50′ and 53, which are not visible in this exemplary embodiment, are coated as well. Surface 50′ and surface 53′ are diametrically opposed to surfaces 50 and 53.

The exemplary embodiment according to FIG. 3b shows a cuboid permanent magnet 38, where only four of six sides are coated. These are surfaces 53 and 53′ as well as 44 and 44′.

As will still be explained in the following text, these four mentioned surfaces are the surfaces that adjoin the surface of the seat.

FIG. 3c shows a permanent magnet 38, which has a rhombic base surface 50 and likewise is prismatic. In this case the two surfaces 44 and 44′ are coated. These two surfaces 44 and 44′ are two end faces, which are coated by coating material 47.

The cuboid shown in FIG. 3d is coated overall and on all sides by coating material 47.

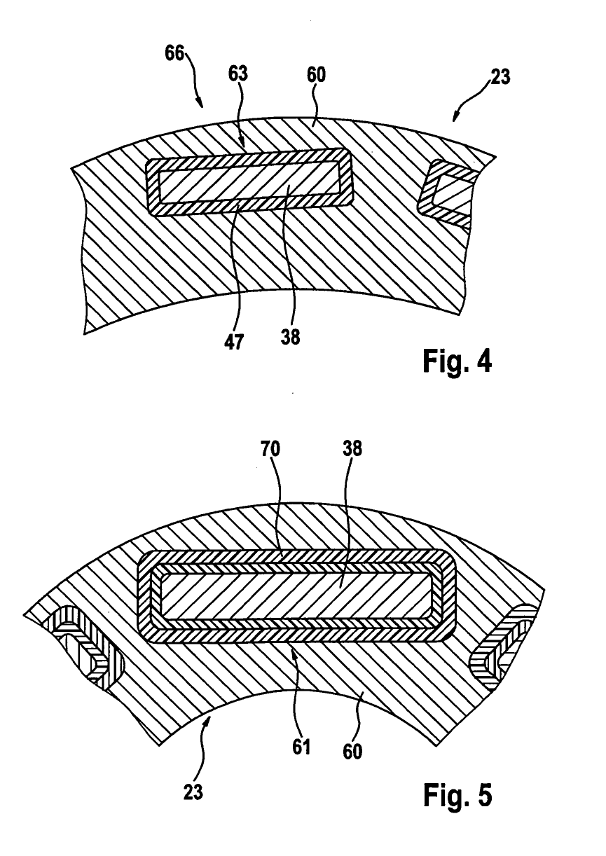

FIG. 4 shows rotor 23 of electric machine 20 in a partial view. A lamella 60 of this rotor 23 is shown in a side or sectional view, which via rectangular seat 63 extending across a specific width, i.e., across a specific number of lamellae 60, constitutes. This lamella 60 thus represents with this seat 63 retaining element 66. In this example, a permanent magnet 38, shown in a sectional view, is inserted according to the exemplary embodiment from FIG. 3d. Permanent magnet 38 is therefore surrounded by coating material 47. This permanent magnet was inserted with the aid of the mounting method according to the present invention for fitting a permanent magnet 38 in a retaining element 66; permanent magnet 38 is held by a coating material 47, the at least one permanent magnet 38 first being at least partially coated by an elastic coating material 47 prior to being fitted in retaining element 66 or seat 63, and is mounted in the retaining element (rotor 23) in a subsequent step.

Within the scope of this mounting method, it is provided that coating material 47 is an elastomer, a copolymerized plastic of duroplast and thermoplast, or a polymer mixture, for example.

It is provided that coating material 47 covers permanent magnet 38 on one side or a plurality of sides 44, 44′, 50, 50′, 53, 53′. After permanent magnet 38 (FIG. 3d) has been coated by coating material 47, it has been inserted in seat 63 of the electromagnetically excitable component (rotor 23) of electric machine 20, which may be the rotor. Taking coating material 47 and its dimensions into account, permanent magnet 38 is dimensionally adapted in such a way that a press-fit exists between permanent magnets 38 provided with coating material 47, and seat 63.

FIG. 5 shows permanent magnet 38 in seat 61 of rotor 23 or its packeted lamellae 60. In this case, permanent magnet 38 has an additional adhesive layer 70 for fixing it in place in seat 63 of electromagnetically excitable component 23 of electric machine 20, the adhesive layer having been applied on this permanent magnet 38 or its coating material 47. This adhesive layer provides adhesion between permanent magnet 38 or its coating material 47 and seat 61 of electromagnetically excitable component 23.

Starting from the exemplary embodiment according to FIG. 4, in order to fix permanent magnet 38 in place in seat 61 of electromagnetically excitable component 23 of electric machine 20, it is also provided that coating material 47 is an expandable material, which expands under the action of an internal or external reaction-triggering arrangement. This means that, for example, coating material 47 is expandable and, for example, expands under the action of radiation or heat as an external reaction-triggering arrangement, and thereby expands. This would cause permanent magnet 38, for example, to be retained in seat 61 in a more robust and particularly excellent manner due to the expansion of coating 47.

According to another exemplary embodiment, which is not shown further here, and proceeding from FIG. 4, coating material 47 could also have an internal reaction-triggering arrangement, which is a crosslinking arrangement, for instance. Such a crosslinking arrangement, which usually crosslinks plastics, generates heat during the reaction, which thereby affects, for example, an expansive component of coating 47 such that it expands.

Starting from the exemplary embodiment according to FIG. 5, adhesive layer 70 could also include the internal reaction-triggering arrangement or react to an external reaction-triggering arrangement, as already mentioned, and expand as a result.

Finally, an electric machine is provided, which has a permanent magnet 38 which is mounted according to one of the above exemplary embodiments.

1-10. (canceled)

11. A mounting method for fitting at least one permanent magnet in a retaining element, the at least one permanent magnet being held by a coating material, the method comprising:
prior to fitting the at least one permanent magnet, at least partially coating the at least one permanent magnet with an elastic coating material; and
fitting the at least one permanent magnet in the retaining element after partially coating the at least one permanent magnet.

12. The mounting method of claim 11, wherein the coating material includes at least one of an elastomer, a copolymerized plastic of duroplast and thermoplast, and a polymer mixture.

13. The mounting method of claim 11, wherein the coating material covers the permanent magnet on one side or a plurality of sides.

14. The mounting method of claim 11, wherein following the coating, the permanent magnet having the coating material is inserted in a seat of an electromagnetically excitable component of an electric machine, which is a rotor.

15. The mounting method of claim 14, wherein the permanent magnet having the coating material is dimensionally adapted so that a press-fit exists between the permanent magnet having the coating material and the seat.

16. The mounting method of claim 15, wherein to fix the permanent magnet in the seat of the electromagnetically excitable component of the electric machine, an additional adhesive layer is applied on the permanent magnet, which imparts adhesion between the permanent magnet and the seat of the electromagnetically excitable component.

17. The mounting method of claim 14, wherein to fix the permanent magnet in the seat of the electromagnetically excitable component of the electric machine, one of the coating material and the adhesive layer is an expandable material, which expands under the action of an internal reaction-triggering arrangement or an external reaction-triggering arrangement.

18. The mounting method of claim 17, wherein the reaction-triggering arrangement is one of a radiation action and heat.

19. The mounting method of claim 17, wherein the internal reaction-triggering arrangement is a crosslinking structure present in the coating material.

20. An electric machine, comprising:
at least one permanent magnet, which is fitted in a retaining element, the at least one permanent magnet being held by a coating material, wherein prior to the at least one permanent magnet being fitted, the at least one permanent magnet is at least partially coated with an elastic coating material, wherein the at least one permanent magnet is fitted in the retaining element after partially coating the at least one permanent magnet.

21. The electric machine of claim 20, wherein the coating material includes at least one of an elastomer, a copolymerized plastic of duroplast and thermoplast, and a polymer mixture.

22. The electric machine of claim 20, wherein the coating material covers the permanent magnet on one side or a plurality of sides.

23. The electric machine of claim 20, wherein following the coating, the permanent magnet having the coating material is inserted in a seat of an electromagnetically excitable component of an electric machine, which is a rotor.

24. The electric machine of claim 23, wherein the permanent magnet having the coating material is dimensionally adapted so that a press-fit exists between the permanent magnet having the coating material and the seat.

25. The electric machine of claim 24, wherein to fix the permanent magnet in the seat of the electromagnetically excitable component of the electric machine, an additional adhesive layer is applied on the permanent magnet, which imparts adhesion between the permanent magnet and the seat of the electromagnetically excitable component.

26. The electric machine of claim 23, wherein to fix the permanent magnet in the seat of the electromagnetically excitable component of the electric machine, one of the coating material and the adhesive layer is an expandable material, which expands under the action of an internal reaction-triggering arrangement or an external reaction-triggering arrangement.

27. The electric machine of claim 26, wherein the reaction-triggering arrangement is one of a radiation action and heat.

28. The electric machine of claim 26, wherein the internal reaction-triggering arrangement is a crosslinking structure present in the coating material.
